(19) United States
(12) Patent Application Publication
(10) Pub. No.: US 2017/0210368 A1
(43) Pub. Date: Jul. 27, 2017

(54) SYSTEM AND METHOD FOR OPERATING A VEHICLE BRAKE

(71) Applicant: Ford Global Technologies, LLC, Dearborn, MI (US)

(72) Inventors: Thomas Svensson, Leichlingen (DE); Ashrit Das, Cologne (DE)

(73) Assignee: Ford Global Technologies, LLC, Dearborn, MI (US)

(21) Appl. No.: 15/417,157

(22) Filed: Jan. 26, 2017

(30) Foreign Application Priority Data
Jan. 27, 2016 (DE) DE102016201179.0

(51) Int. Cl. B60T 8/74; B60T 8/32; B60T 8/40; B60T 8/24

(52) U.S. Cl. CPC B60T 8/74; B60T 8/245; B60T 8/3205; B60T 8/3275; B60T 8/4072; B60T 2201/06; B60T 2220/04

(57) ABSTRACT

A system and method for operating a brake system of a vehicle including determining if the vehicle is stopped. Determining a current brake pressure, a braking deceleration and a dynamic brake pressure corresponding to the braking deceleration. Based on the current brake pressure and the dynamic brake pressure determining a differential brake pressure. A holding brake pressure for holding the vehicle is determined based on the differential brake pressure and operating the brake system with the holding brake pressure.

### CROSS-REFERENCE TO RELATED APPLICATIONS

Not Applicable.

### BACKGROUND OF THE INVENTION

1. Field of the Invention

The invention relates to a system and method for operating a brake system of a vehicle.

2. Description of Related Art

Brake systems of motor vehicles generally include hydraulic brake systems that act on the wheels of the respective motor vehicle. In this context, a master brake cylinder, activated with a brake pedal, generating a brake pressure in a pressure chamber filled with brake fluid is provided. The brake pressure passed on via hydraulic lines to individual wheel brake cylinders assigned to the wheels that move brake linings, resting on brake calipers under the pressure of the brake fluid, into abutment with a brake drum or a brake disk. In this way, a braking force acting on the wheel connected to the brake drum or brake disk can be generated and metered. A braking force booster boosts the braking force. The driver of the motor vehicle activates the braking process by depressing the brake pedal or it is automatically activated by an autonomous driver assistance system. Such an autonomous system is, for example, an emergency braking assistance system, that automatically initiates a braking process, if an obstacle is detected in the driving direction of the motor vehicle or an automatic cruise control stop and go is detected. Electronically controlled driver assistance systems are known, for example driving dynamic control systems that permit the brake pressure acting on all or some of the wheel brake cylinders to be changed as a function of the driving state sensed by sensors.

During vehicle operation, a situation occurs wherein driver brakes the vehicle to a stationary state by activating the brake pedal. The vehicle should remain in a stationary state, for example, until the driver activates the accelerator pedal. Here, it is desirable that the motor vehicle remains in a stationary state even if the driver activates the brake pedal with a relatively small force or releases the brake pedal. The brake system operates such that the brake pressure generated by the driver by activating the brake pedal for stopping also maintains the stationary state of the motor vehicle, even when the driver releases the brake pedal again. Likewise, the brake pressure generated by an autonomous driver assistance system for stopping the motor vehicle system also holds it in the stationary state. The brake pressure is held, for example, by closing corresponding valves. However, the motor vehicle may not remain in a stationary state but instead begins to roll, in particular if the motor vehicle occurs has stopped on a section of road with a positive or negative gradient.

### SUMMARY OF THE INVENTION

A method for operating a vehicle brake system including determining if the vehicle is stopped and the current brake pressure. The method includes determining a dynamic brake pressure corresponding to a braking deceleration and determining a differential brake pressure based on the current brake pressure and dynamic brake pressure. Based on the differential brake pressure the system and method determines a holding brake pressure for holding the vehicle and operating the brake system with the holding brake pressure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flowchart of an exemplary embodiment of the invention;

FIG. 2 is a schematic illustration of braking force associated with residual brake drag as a function of the brake pressure.

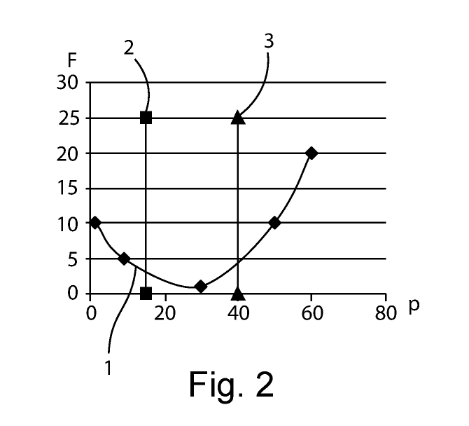

### DETAILED DESCRIPTION OF THE PREFERRED EMBODIMENTS

The following description of the preferred embodiment(s) is merely exemplary in nature and is in no way intended to limit the invention, its application, or uses.

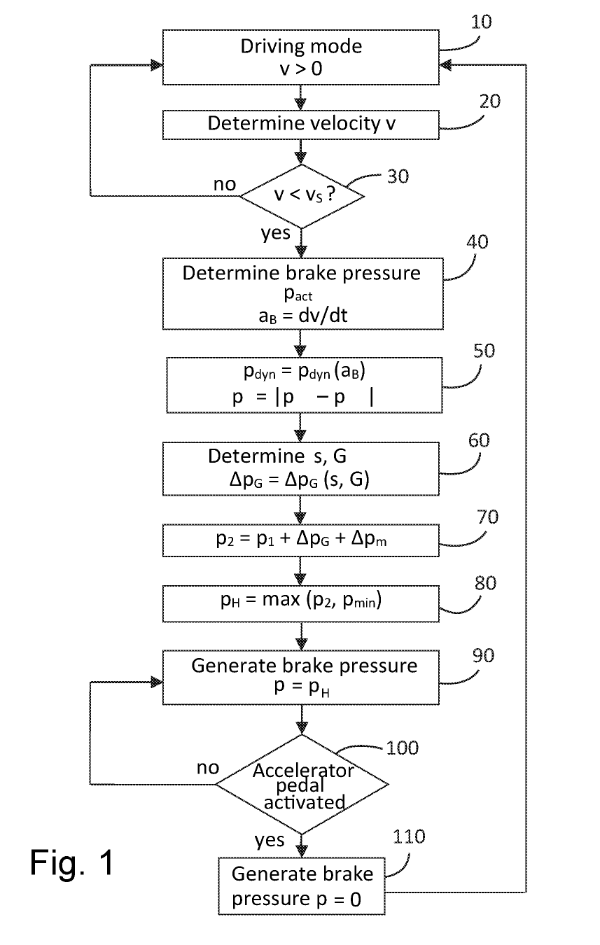

FIG. 1 is a flowchart according to an exemplary embodiment of the present invention. Initially, in step 10, the motor vehicle is in a driving mode moving at an initial velocity v, wherein the velocity v is greater than zero, wherein v>0.

In step 20, the method determines the velocity v. For example, the signal or readout of a velocity sensor is monitored to determine or sense the current velocity v of the motor vehicle. Step 30 compares the velocity v of the vehicle with a threshold value vₛ. If the current vehicle velocity v drops below the velocity threshold value vₛ, predetermined and in an order of magnitude considering the measuring uncertainty of the velocity sensor, the method considers the vehicle stopped.

In step 40, the method determines the brake pressure p_{act} that is currently active or applied on the wheel brake cylinders. For example, a brake pressure sensor is monitored to determine or sense the brake pressure p_{act}. In addition, braking deceleration a_{B}, reached directly before stopping, is determined by derivation over time of the velocity sensed by the velocity sensor. Determining braking deceleration a_{B} may also use velocity values sensed directly before stopping. The velocity values or the deceleration determined therefrom may to be stored.

In step 50, a dynamic brake pressure p_{dyn} is determined based on the braking deceleration a_{B}. The dynamic brake pressure p_{dyn} is the brake pressure that must act on the wheel brake cylinders on a level road to bring about the braking deceleration a_{B}, and is extracted from a type-specific characteristic diagram stored in a memory device. In this context, corresponding sensors sense the current load, a degree of wear of the brake linings, and if appropriate, consider further parameters such as the temperature of the brakes. The differential pressure value p₁, wherein p₁=|p_{act}−p_{dyn}|, is taken as a measure for further influences acting on the driving movement of the motor vehicle in the case of a stopping process, in particular a positive gradient or a negative gradient of the road or a torque from the train drive acting on a drive axle.

In step 60, to improve accuracy, a drive position correction Δp_{G} is performed as a function of the engaged drive position of an automatic transmission of the motor vehicle. For this purpose, the drive position G in the case of stopping or just before stopping is sensed, and the sign of the inclination s of the motor vehicle in the direction of travel is extracted from the signal of an inclination sensor or an acceleration sensor after the stopping. This detects whether the vehicle has stopped on a section of road with a positive gradient (s>0) or on a section of road with a negative gradient (s<0). If appropriate, further parameters can be considered, for example the load distribution over the axes of the motor vehicle.

If the vehicle is located uphill (s>0), the drive position correction Δp_{G} is determined as a function of the engaged drive position N, D or R as follows:

Δp_{G}=Δp(NR), Drive position N

Δp_{G}=Δp(NR)+Δp(ND) Drive position D

Δp_{G}=0 Drive position R

In this context, Δp (NR) or Δp (ND) is that brake pressure which is sufficient to generate a braking force which corresponds to the absolute value to the difference between the torques applied to a drive axle by the drive train in the case of the changeover from the drive position N into the drive position R or in the case of a changeover from drive position N to drive position D. As a result, a deceleration force applied by the drive train, in particular by the transmission and the engine, in the case of stopping can be considered.

If the vehicle is located downhill (s<0), the drive position correction Δp_{G} is determined as a function of the engaged drive position N, D or R as follows:

Δp_{G}=Δp(ND), Drive position N

Δp_{G}=0 Drive position D

Δp_{G}=Δp(NR)+Δp(ND) Drive position R

In step 70, the drive position correction Δp_{G} is added to the determined differential brake pressure p₁. Furthermore, a safety margin Δpₘ is added which additionally ensures that the vehicle does not begin to roll after the stopping, even if the driver releases the brake pedal: p₂=p₁+Δp_{G}+Δpₘ

The method also considers a minimum value pₘᵢₙ of the brake pressure resulting from residual brake drag, illustrated in Fig. in random units. As shown by the curve 1, representing dependence of the tractive force F caused by residual brake drag on the brake pressure p applied to stop the motor vehicle, a non-negligible braking force occurs both in the case of a very low brake pressure and with a very high brake pressure through residual brake drag, even if the brakes are released after the stationary state when starting occurs.

This braking force brings about, in particular in the case of a brake pressure below a minimum value pₘᵢₙ, line 2, and above a maximum value, line 3, considerable wear of the brake linings and a considerable additional consumption of fuel. In step 80, when the determined brake pressure p₂ is below the minimum value pₘᵢₙ, the brake pressure is correspondingly increased, i.e. the holding brake pressure p_{H} is in this case set to the minimum value pₘᵢₙ, wherein p_{H}=max (p₂, pₘᵢₙ).

In step 90, a pressure-generating device of the brake system, for example an electrohydraulic control unit of a vehicle movement dynamics control system or a motor-operated pressure-generating cylinder is actuated to generate the determined holding brake pressure p_{H}, so that a brake pressure, p=p_{H}, is applied to the wheel brake cylinders.

The brake pressure p of step 90 is such that the vehicle does not unintentionally begin to roll, even it has been stopped on a positive gradient, and the driver entirely or partially releases the brake pedal. Step 100 determines if the accelerator pedal of the vehicle is activated, for example depressed by the vehicle operator. The method maintains the brake pressure p, for example by further corresponding actuation of the pressure-generating device, or by closing of valves, until activation of the accelerator pedal is detected in step 100. Upon detecting activation of the accelerator pedal in step 100 the method moves to step 110 wherein the brake pressure is reduced, in particular reduced to zero, p=0, and the normal driving mode in which the driver controls the acting brake pressure p by activating the brake pedal is resumed.

The brake system of the motor vehicle according to one embodiment includes a hydraulic or pneumatic brake system having at least one wheel brake device acting on at least one wheel of the motor vehicle and includes a wheel brake cylinder using a pressure fluid for applying a brake pressure. In one example, the brake system has a multiplicity of wheel brake devices, a brake pressure applied to each device wherein respective devices act on a corresponding one wheel, so in a stationary state the same brake pressure acts on all the wheel brake devices.

Initially stopping of the motor vehicle, or determining if the vehicle is stopped, is detected; i.e., it is determined whether the motor vehicle changes from a driving movement or state to a stationary state. For this purpose, the velocity of the motor vehicle, for example, sensed by a velocity sensor can be monitored continuously or at short time intervals to determine whether the velocity of the motor vehicle reaches the value zero or a value near to zero, for example a value below a predefinable velocity threshold value.

Upon determining or detecting that the motor vehicle has been stopped, or is stationary, the current brake pressure and a braking deceleration of the motor vehicle are determined, in one example using vehicle sensors such as velocity or acceleration sensors and brake pressure sensors. Current brake pressure is the brake pressure in the brake system when the motor vehicle stops; a brake pressure can also be sensed that is before or after the time of stopping by a time interval shorter than the time scale in which the brake pressure generated by the driver or an autonomous driver assistance system typically changes. For example, a signal of a pressure sensor of the brake system or else a value of the brake pressure determined supplied by a control device of the brake system can be used to sense the current brake pressure. The braking deceleration of the motor vehicle is that with which the motor vehicle has been decelerated directly before the stationary state is reached. The braking deceleration can be determined, for example, by deriving over time the velocity of the motor vehicle determined from the signal of the velocity sensor, just before the time of stopping.

According to the invention a dynamic brake pressure is determined that corresponds to the sensed braking deceleration, i.e. that brake pressure with which the brake system of the motor vehicle must be operated or which would have to be applied to at least one wheel brake device to reach the sensed braking deceleration on a flat road. The dynamic brake pressure can, for example, be calculated in a respective current fashion or be extracted from a table that is predefined on a type-specific basis by means of the sensed braking deceleration. In this context, it is possible to provide further parameters such as the loading of the motor vehicle, a degree of wear of the brake linings and/or a temperature of the brakes sensed by further sensors and taken into account during the determination of the dynamic brake pressure; for example, a corresponding type-specific characteristic diagram can be predefined for this.

The differential brake pressure is determined based on the sensed current brake pressure and the determined dynamic brake pressure with the differential brake pressure calculated as an absolute value of the difference between the current brake pressure and the dynamic brake pressure. Then, based on the differential brake pressure, a holding brake pressure is determined and the brake system of the motor vehicle is operated to generate the holding brake pressure. The holding brake pressure determined in this way is applied to at least one wheel brake device, and preferably the wheel brake cylinders of all the wheel brake devices of the motor vehicle after the motor vehicle was stopped; i.e., in the stationary state of the motor vehicle, to hold the motor vehicle in the stationary state.

As explained, a pressure-generating device of the brake system can be correspondingly actuated, for example an electrohydraulic control unit of a vehicle movement dynamics control system or one or more motor-driven pressure-generating cylinders of a “brake-by-wire” system. The holding brake pressure can be maintained by closing valves or by corresponding further actuation of the pressure-generating device, wherein in the latter case the additional advantage can be achieved that no audible activation of the valves takes place. The holding brake pressure is preferably maintained even if, for example, the driver releases the brake pedal until a relevant change is detected in the requirements made of the brake system and of the drive system of the motor vehicle. Accordingly, when the driver activates the accelerator pedal the brake system is operated to generate a changed brake pressure that permits, for example, release of the brakes and a renewed driving movement of the motor vehicle.

Determining a differential brake pressure that constitutes the absolute value of the difference between the current brake pressure in the case of stopping and the dynamic brake pressure corresponding to the braking deceleration up to stopping and a holding brake pressure as a function of the differential brake pressure achieves the holding brake pressure dependent on the positive gradient or the negative gradient of the road where the vehicle has been stopped, to hold the vehicle in the stationary state in a wide range of positive or negative gradients of a road. Because the brake system of the motor vehicle operates to generate the holding brake pressure and apply the holding brake pressure to the wheel brake cylinders, it is therefore possible to avoid rolling of the motor vehicle, largely independently of whether the motor vehicle has been stopped on the flat, on a section of road with a positive gradient or on a section of road with a negative gradient. Rolling of the motor vehicle can therefore be avoided even if the motor vehicle has been stopped on a section of road with a positive gradient or on a section of road with a negative gradient and the driver activates or releases the brake pedal with reduced force after the stopping or if the motor vehicle has been stopped by an autonomous system.

In one embodiment of the invention, the motor vehicle has an automatic transmission with a multiplicity of drive positions. Initially the engaged drive position is sensed, a drive position correction dependent on the sensed drive position is determined, and the holding brake pressure is determined considering the drive position correction. The drive position is the drive position engaged with stopping or else for a brief time before the detection of the stopping of the motor vehicle. The current drive position is preferably that drive position effective at the time of sensing of the braking deceleration based on which the dynamic brake pressure is determined. The drive position correction is determined in such a way it constitutes a brake pressure that corresponds to the brake pressure that generates a braking torque acting on a drive axle of the motor vehicle so it corresponds to the difference of the torque of the drive train applied to a drive axle of the motor vehicle with a changeover of the drive position. These torques can be, for example, drive torques or braking torques generated by the engine and/or by the transmission. The changeover of the drive position can be a changeover from the drive position N to the drive position D or to the drive position R. The drive position correction can also correspond to a plurality of changeovers of the drive positions, for example from N to D and from N to R. In this context, the drive position changeover used may be dependent on the driving situation. In addition, during determining the drive position correction, further operating parameters of the motor vehicle are considered, for example the position of the accelerator pedal and/or the current rotational speed of the engine of the motor vehicle. The drive position correction can be obtained, for example, from a table on a type-specific basis or a characteristic diagram. Because the drive position correction depends on the drive position of the automatic transmission, it is possible for a braking torque or drive torque of the engine or of the drive train of the motor vehicle to be considered in determining an optimum holding brake pressure. As a result, the determination of the holding brake pressure is made possible wherein unintentional rolling is avoided with greater certainty and unnecessarily high braking pressure is not generated.

The drive position correction is dependent on an inclination of the motor vehicle in the direction of travel, at least on the sign of the inclination of the motor vehicle. In particular, the absolute value and/or the sign of the drive position correction depends on whether in the stationary state the motor vehicle is inclined in the forward direction or in the rearward direction of the motor vehicle. The road gradient can be inferred from the inclination of the motor vehicle, in particular it can be inferred whether stopping has taken place on a section of road with a positive gradient or on a section of road with a negative gradient. The inclination of the motor vehicle can be measured here, for example, with an inclination sensor or also with an acceleration sensor. Signals from other sensors, for example from sensors sensing the load distribution over the axles of the motor vehicle can be used. As a result, a further improved determination of the holding brake pressure, optimum for holding of the motor vehicle on a section of road with a positive gradient or on a section of road with a negative gradient, is made possible.

In one exemplary embodiment, the drive position correction is determined when the motor vehicle has been brought to the stationary state on a positive gradient, i.e. has been stopped “uphill” by the following, in the case of a current drive position N, the drive position correction corresponds to the absolute value of the change in the torque applied by the drive train in the case of the changeover between the drive positions N and R. If the current drive position is D, the drive position correction is determined such that it represents the sum of the brake pressures that respectively correspond to the absolute value of the change in the torques of the drive train applied to the drive axle in the case of a changeover of the drive position between N and R as well as between N and D. In the case of a current drive position R, the drive position correction is zero, i.e. no drive position correction is performed.

When the motor vehicle has been brought to the stationary state on a section of road with a negative gradient, i.e. has been stopped “downhill”, the drive position correction is determined by the following, if the current drive position is N, the drive position correction corresponds to the absolute value of the change in the torque applied by the drive train in the case of the changeover between the drive positions N and D. In the case of a current drive position D, the drive position correction is zero, i.e. no drive position correction is performed. If the current drive position is R, the drive position correction is the sum of the brake pressures that respectively correspond to the absolute value of the change in the torques of the drive train applied to the drive axle with a changeover of the drive position between N and R and between N and D.

The drive position correction determined in this way is added to the differential brake pressure to determine the holding brake pressure. In this way, a precise determination of the holding brake pressure that will hold the motor vehicle in the stationary state, in particular even if another drive position is engaged in the stationary state is made possible.

In a further embodiment, the holding brake pressure includes a safety margin. In particular, the determined holding brake pressure is higher, by a predefined safety margin, than the determined holding brake pressure that considers the differential brake pressure and, if appropriate, the drive position correction resulting in increased resistance to rolling of the motor vehicle from the stationary state.

One embodiment of the method includes a holding brake pressure corresponding to at least one minimum pressure selected so residual brake drag is entirely or largely avoided. The minimum pressure can be predeterminable, for example can be predetermined on a type-specific basis or can be determined, for example, as a function of operating parameters, for example a wear value and/or a temperature of the at least one wheel brake device of the motor vehicle. With the determined holding brake pressure being lower than a minimum pressure determined to reduce the residual brake drag, the holding brake pressure is therefore set to the minimum pressure. As a result, more economical and low-wear operation of the motor vehicle or of the brakes in the motor vehicle can be achievable.

A brake system according to the invention for a motor vehicle may include at least one wheel brake device acting on at least one wheel of the motor vehicle to generate a braking torque and includes at least one wheel brake cylinder. The brake system also has a fluid system, with fluid lines for applying a brake fluid under a brake pressure to the at least one wheel brake cylinder, to generate a braking action which can be controlled by the brake pressure, and at least one pressure-generating device for generating or changing the brake pressure. The brake system preferably has a multiplicity of wheel brake devices which act on, in each case, at least one wheel and, at least in the stationary state of the motor vehicle, the same brake pressure generated by the at least one pressure-generating device, can be applied. The pressure-generating device is, for example, a fluid pump, a motor-operated pressure-generating cylinder and/or a pressure reservoir with correspondingly actuable valves. Such a pressure-generating device can be arranged in a manner known with a vehicle movement dynamic control system. The brake system may include a master brake cylinder activated with a brake pedal and a brake booster generating the brake pressure in the fluid system. The brake system can be actuated by an autonomous driver assistance system to generate a braking effect.

The brake system may also include an electronic control device configured to detect stopping of the motor vehicle, and may include, for example, velocity sensor generating a velocity signal. The control device may determine a current brake pressure and a braking deceleration of the motor vehicle. To determine the current brake pressure, the control device may include, for example, a brake pressure sensor generating a brake pressure signal when stopping of the motor vehicle. The control device may also receive, read, or use a set point value of the brake pressure to actuate the brake system. The control device can be configured to determine braking deceleration, for example by sensing and deriving over time the velocity of the motor vehicle just before the stopping. Furthermore, the electronic control device is configured to determine a dynamic brake pressure, and can for this purpose include a storage means for storing a table, predefined on a type-specific basis or a characteristic diagram, by which table or characteristic diagram the dynamic brake pressure can be determined based on the sensed braking deceleration. The control device is also designed to calculate, based on the current brake pressure and the dynamic brake pressure, a differential brake pressure as an absolute value of the difference between the current brake pressure and the dynamic brake pressure, to determine a holding brake pressure based on the differential brake pressure, and to actuate the pressure-generating device to generate the holding brake pressure, so that the holding brake pressure is applied to the at least one wheel brake cylinder of the motor vehicle after the motor vehicle has stopped or is in a stationary state. For this purpose, the control device can have suitable processor. Furthermore, the control device can be designed to actuate the pressure-generating device to generate the holding brake pressure, until, owing to a change in a sensor signal, for example an accelerator pedal sensor which indicates the activation of the accelerator pedal by the driver, a change in the requirements is detected, and then to bring about a corresponding change in the active brake pressure, for example release of the brakes. The control device of the brake system can be an electronic control device of the motor vehicle or part of such an electronic control device.

By equipping a motor vehicle with the brake system according to the one embodiment of the present invention it is possible after stopping to hold the motor vehicle in the stationary state, largely independently of the positive gradient or the negative gradient of the road where the motor vehicle has been stopped, and therefore rolling is avoided, even if the driver activates or releases the brake pedal with a relatively small force or if the stopping has been brought about by an autonomous driver assistance system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for operating a brake system of a vehicle comprising:
determining vehicle velocity and comparing said vehicle velocity to a threshold value wherein when said vehicle velocity is below said threshold value said vehicle is considered stopped;
determining a current brake pressure and a braking deceleration;
determining a dynamic brake pressure corresponding to the braking deceleration;
determining a differential brake pressure;
determining a holding brake pressure for holding the vehicle stationary based on the differential brake pressure; and
operating the brake system with the holding brake pressure.

2. The method of claim 1 wherein the vehicle includes an automatic transmission having multiple drive positions;
determining a current drive position and a drive position correction based on the drive position; and
determining the holding brake pressure based on the drive position correction.

3. The method of claim 2 wherein the drive position correction is based on an inclination of the vehicle in a direction of travel.

4. The method of claim 1 wherein the holding brake pressure is determined considering a safety margin.

5. The method of claim 1 wherein the holding brake pressure is set to a minimum pressure.

6. A brake system for a motor vehicle comprising:
a wheel brake that acts on a wheel of the motor vehicle to generate a braking torque;
a fluid system with fluid lines supplying a brake fluid under a brake pressure to said wheel brake;
a pressure-generating device for generating said brake pressure;
a velocity sensor;
a brake pressure sensor; and
a control unit monitoring an output of said velocity sensor and said brake pressure sensor and determining a holding brake pressure based on the output of said velocity sensor and said brake pressure sensor.

7. The system of claim 6 including an inclination sensor generating an output corresponding to an inclination of the motor vehicle; and
determining said holding pressure based on said output of said inclination sensor.

8. The system of claim 6 including said the motor vehicle including an automatic transmission having a multiplicity of drive positions;
a drive position sensor generating an output corresponding to a current drive position; and
determining a drive position correction dependent on said output of said drive position sensor wherein said holding brake pressure takes into said drive position correction.

9. The system of claim 8 including an accelerator pedal and an accelerator pedal sensor generating an output corresponding to accelerator pedal activation;
determining accelerator pedal activation based on an output of said accelerator pedal sensor; and
reducing the brake pressure when said accelerator pedal is activated.

10. A method for operating a vehicle brake system comprising:
determining stopping of the vehicle;
determining a current brake pressure;
determining a dynamic brake pressure corresponding to a braking deceleration;
determining a differential brake pressure based on the current brake pressure and dynamic brake pressure;
determining a holding brake pressure for holding the vehicle based on the differential brake pressure; and
operating the brake system with the holding brake pressure.

11. The method of claim 10 including using an inclination sensor to generate an output corresponding to an inclination of the vehicle and determining the holding pressure based on the output of the inclination sensor.

12. The method of claim 10 wherein said vehicle includes an automatic transmission having multiple drive positions and a drive position sensor generating an output corresponding to a current drive position; and
determining a drive position correction dependent on the output of the drive position sensor and determining the holding brake pressure based on the output of the drive position sensor.

13. The method of claim 10 wherein said vehicle includes an automatic transmission having multiple drive positions and a drive position sensor generating an output corresponding to a current drive position;
determining a drive position correction dependent on the output of the drive position sensor and determining the holding brake pressure based on the output of the drive position sensor; and
using an inclination sensor to generate an output corresponding to an inclination of the vehicle and determining the holding pressure based on the output of the inclination sensor.

14. The method of claim 13 including an accelerator pedal and an accelerator pedal sensor generating an output corresponding to accelerator pedal activation;
determining accelerator pedal activation based on an output of the accelerator pedal sensor; and
reducing the brake holding pressure when the accelerator pedal is activated.
